(19) United States
(12) Patent Application Publication
(10) Pub. No.: US 2005/0236566 A1
(43) Pub. Date: Oct. 27, 2005

(54) Scanning probe microscope probe with integrated capillary channel

(76) Inventor: Chang Liu, Champaign, IL (US)

Correspondence Address: EVAN LAW GROUP LLC, 566 WEST ADAMS, SUITE 350, CHICAGO, IL, 60661, US

(21) Appl. No.: 10/831,944

(22) Filed: Apr. 26, 2004

(51) Int. Cl. G12B 21/02

(52) U.S. Cl. 250/306; 73/105

(57) ABSTRACT

A scanning probe microscope probe is disclosed. The scanning probe microscope probe includes a handle and a cantilever shank connected with the handle. The cantilever shank has at one end a base connected with the handle and at an opposing end a tip. The cantilever shank forms a capillary channel between the base to the tip of the cantilever shank.

### FEDERALLY SPONSORED RESEARCH OR DEVELOPMENT

This invention was made with Government support under Contract Number NW 0650 300F245 awarded by the Defense Advanced Research Projects Agency (DARPA). The Government has certain rights in the invention.

### BACKGROUND

This invention relates generally to scanning probe microscope (hereinafter “SPM”) probes for use in scanning probe microscopy, and in particular, to an SPM probe formed with an integrated capillary and to a method of manufacturing the same.

A scanning probe microscope is an important instrument for science and technology. One of the first scanning probe microscopes ever developed was called a Scanning Tunneling Microscope (STM). Another device within the scanning probe microscope family is an Atomic Force Microscope (hereinafter “AFM”). Nowadays, scanning probe microscopes are used to measure surface properties with atomic resolution. For example, scanning probe microscopes can be used to observe the structure of double helix of DNA. The capability of scanning probe microscopes has spread to include imaging of magnetic, optical, thermal, electrostatic charges, and many more. Scanning probe microscopes are also used for biological sensors as the static bending and resonant frequency of a scanning probe microscope is sensitive to the biochemical substances absorbed on it. Scanning probe microscopes are also used to perform nanolithography, such as dip pen nanolithography, and nanomanipulation, that is, interacting with objects on a molecular and an atomic scale.

Scanning probe microscopes use a probe having a flexible cantilever beam with a tip at the distal end to perform their measurements. The cantilever beam is very soft, often with a force constant on the order of 0.1 N/m or less. The tip is used to interact with the surface of interest. In an AFM for example, the repulsive force between the surface and the tip causes the cantilever beam to bend. The minute amount of bending in the cantilever beam is picked up by using sensitive instruments, such as by optical deflection. By raster scanning the tip over a sample surface area, a local topological map can be produced. If the tip of the probe is relatively sharp, the topological map may be made with atomic resolution. Typically, the radius of curvature of tips range below 500 nanometers.

Needless to say, the SPM probe's cantilever beam with integrated tip is a performance limiting device in the overall scanning probe microscope system. Many research groups as well as companies that commercialize the scanning probe microscope spend much time to develop the cantilever beam and the tip of the probe. Using current fabrication methods, the cantilever beam is typically made of silicon nitride or single crystal silicon while the tip is typically etched by bulk silicon etching using wet etching chemicals or plasma etching. There are a number of major drawbacks to existing fabrication methods. For example, the cantilevers are made of inorganic thin films such as silicon nitride or single crystal silicon which require a high temperature process and multiple process steps, such as a bulk silicon etch, to produce. Furthermore, certain processes require removal of a substrate upon which the probes are fabricated upon in order to remove the probe, and more specifically, the cantilever, from the substrate. Thus, a need exists for an improved method for fabricating an SPM probe.

Additionally, there is a need for an improved method for fabricating an SPM probe, including an array of SPM probes, using an efficient process, low cost materials, and a uniform profile. Such probes can then be used in a variety of ways, such as, for SPM, chemical/biosensing, and nanolithography such as DPN. There is also a need for an improved method when using SPM probes for microcontact printing. Microcontact printing (μ CP) is a soft lithography method capable of creating micro-scale structures on a microscopic level. Microcontact printing typically uses a stamp to transfer chemical or biological materials, also known as “ink,” onto a solid substrate. Microcontact printing creates impressions with the patterned stamp by placing the stamp near, or in contact with, the solid substrate. Repeated contact with the solid substrate can form dots, lines, curves, and other such shapes. The stamp can be made of a variety of materials, such as metals, polymers, and elastomeric materials. One of the more commonly used elastomeric materials is poly(dimethylsiloxane) (PDMS), which is an inert material that is compatible with many chemical and biological inks. Microcontact printing has been used to pattern self-assembled monolayers of alkanethiols, proteins, chemical precursors, and other biological materials on a variety of substrates. Microcontact printing has also been used to transfer chemical or biological materials (inks) onto a solid substrate. However, microcontact printing invariably requires a dedicated photolithography mask to produce inverse mold features, and is limited with respect to multi-ink and alignment registration capabilities. Additionally, the production of the mask can be relatively costly and time consuming, particularly when sub-micrometer features are desired. Moreover, for many applications, such as the generation of proteomic and gene chips, well aligned, sub-micrometer scale features made of many different inks are desirable. Thus, a need exists for a less costly and less time consuming method for microcontact printing.

Additionally there is a need for an improved method when using SPM probes for microcontact printing and nanolithography. One problem with both microcontact printing and nanolithography is the delivery of ink to the tip of the SPM probe. Typically, ink is delivered by dipping the tip of an SPM probe into a reservoir filled with ink. Once the SPM probe is inked, the tip of the probe must be moved and placed in contact with a substrate upon which the ink is to be transferred. This process requires repeatedly moving the SPM probe back and forth from the ink reservoir to the substrate. Thus, a need exists for a less costly and less time consuming method for microcontact printing and nanolithography.

### BRIEF SUMMARY

According to one aspect of the present invention, a method for fabricating a scanning probe microscope probe having a handle and a cantilever shank is provided. The cantilever shank has at one end a base connected with the handle and at and opposing end a tip. The method includes forming a capillary channel between the base to the tip of the cantilever shank. In one embodiment, the width W₁ of the capillary channel ranges from 1 nanometers to 50 nanometers. In one embodiment, the capillary channel is formed using focused ion beam etching.

According to another aspect of the present invention, a scanning probe microscope probe is provided. The scanning probe microscope probe includes a handle and a cantilever shank connected with the handle. The cantilever shank has at one end a base connected with the handle and at an opposing end a tip. The cantilever shank forms a capillary channel between the base to the tip of the cantilever shank. In one embodiment, the width W₁ of the capillary channel ranges from 1 nanometers to 50 nanometers. In another embodiment, the capillary channel is formed using focused ion beam etching.

### BRIEF DESCRIPTION OF THE DRAWINGS

FIG. 1 is a perspective view of an SPM probe, in accordance with one embodiment of the invention.

FIG. 2 is an enlarged partial perspective view of the SPM probe in FIG. 1, in accordance with one embodiment of the invention.

FIG. 3 is a cross-sectional perspective view of the SPM probe in FIG. 1 along lines 3-3, in accordance with one embodiment of the invention.

FIG. 4 is a a cross-sectional perspective view of the SPM probe in FIG. 3 with an added retaining cap and a plug.

FIG. 5 is an enlarged partial perspective view of an SPM probe, in accordance with one embodiment of the invention.

FIG. 6 is a partial cross-sectional view of the SPM probe in FIG. 5, in accordance with one embodiment of the invention.

FIG. 7 is a perspective view of an SPM probe, in accordance with one embodiment of the invention.

FIG. 8 is a partial top view of an SPM probe, in accordance with one embodiment of the invention.

FIG. 9 is a partial top view of an SPM probe, in accordance with one embodiment of the invention.

FIG. 10 is a partial top view of an SPM probe, in accordance with one embodiment of the invention.

FIG. 11 is a partial top view of an SPM probe, in accordance with one embodiment of the invention.

It should be appreciated that for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### DETAILED DESCRIPTION

The present invention describes a scanning probe microscope (SPM) probe with a capillary channel and a method for fabricating the same. The SPM probe includes a handle and a cantilever shank connected with the handle, wherein a capillary channel is formed in the cantilever shank. In one embodiment, the capillary channel has a width W₁ from 1 nanometer to 50 nanometers. In one embodiment, the capillary channel is formed in the cantilever shank using focused ion beam etching. The capillary channel allows for ink to travel from a reservoir in the handle to a tip at one end of the cantilever shank, supplying ink to the tip and eliminating the need to re-ink the tip by dipping the tip in a well. Additionally, by forming a capillary channel, instead of a traditional tunnel, the structure of the SPM probe is simplified, and the cantilever shank can retain its flexibility.

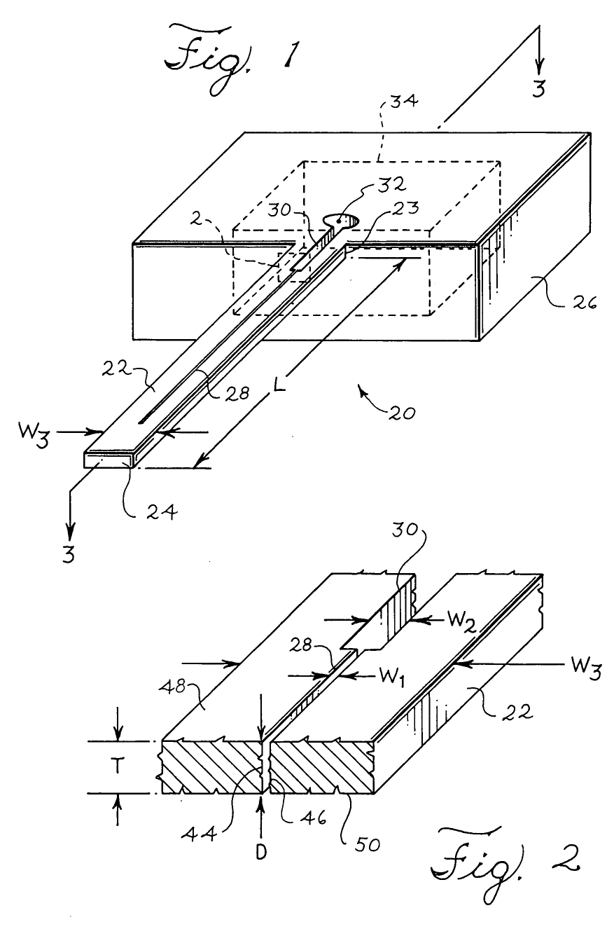

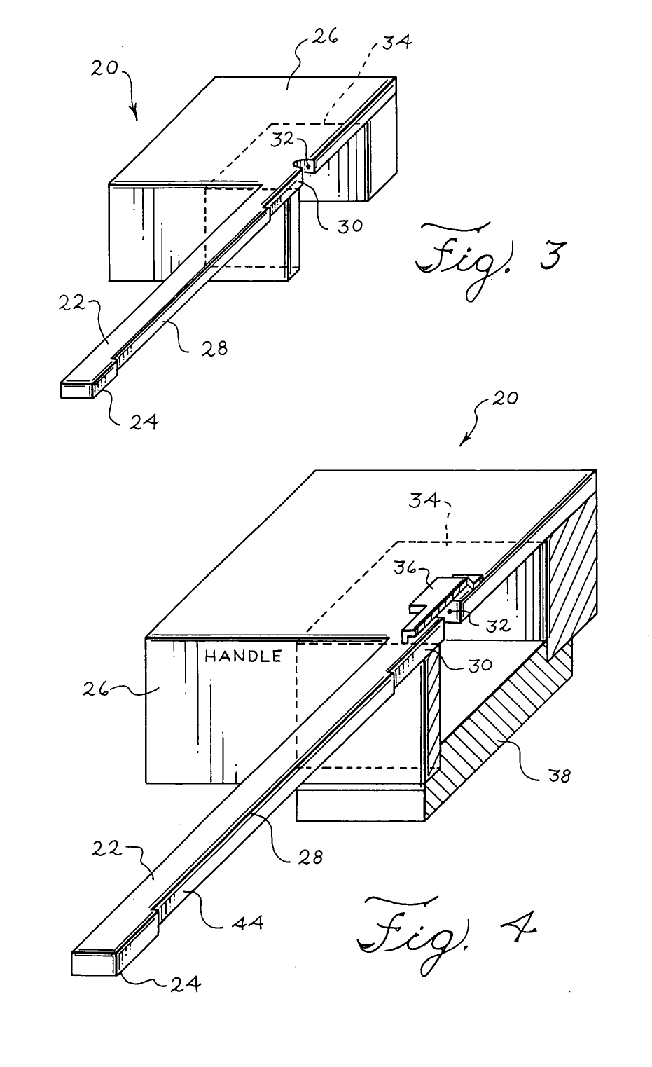

Shown in FIGS. 1-11 are views of SPM probes suitable for use in a scanning probe microscope. Please note that while FIGS. 1-11 illustrate only one probe at a time, arrays of SPM probes may be formed having from tens to hundreds of thousands of SPM probes. In some instances, arrays of SPM probes may have from one-hundred to tens of millions of SPM probes or more. For the sake of clarity, these additional probes have been left out of FIGS. 1-11.

An SPM probe 20 including a handle 26 and a cantilever shank 22 connected with the handle 26 is illustrated in FIG. 1. The handle 26 and the cantilever shank 22 may comprises a variety of materials. In one embodiment, the handle 26 and the cantilever shank 22 each comprise a material selected from the group consisting of metals such as permalloy, copper, tungsten, titanium, aluminum, silver, and gold; oxides such as silicon dioxide, silicon oxide, and silicon oxynitride; nitrides such as silicon nitride and titanium nitride; and polymers such as poly(dimethylsiloxane) (PDMS), polyimide, parylene, and elastomers such as silicone and rubber. Additionally, the handle 26 and the cantilever shank 22 may be formed from a semiconductor substrate, such as silicon.

The cantilever shank 22 has a base 23 at one end and a tip 24 at an opposing end. The base 23 is connected with the handle 26, while the tip 24 used for transferring ink from the SPM probe 20 to a substrate. The tip 24 is connected with or integrally formed with the cantilever shank 22. The tip 24 may take various forms and shapes, such as pyramidal, conical, wedge, and boxed. In one embodiment, the tip 24 takes a pyramidal form, as illustrated in FIGS. 7-11. In one embodiment, the tip 24 and the cantilever shank 22 are integrally formed, as illustrated in FIG. 1. In one embodiment, the tip 24 is flat and is integrally formed at one end of the cantilever shank 22, as illustrated in FIG. 1. The tip 24 may comprise any one of a number of materials. In one embodiment, the tip 24 comprises a material such as photoresist; SU-8; metals such as permalloy, copper, tungsten, titanium, aluminum, silver, and gold; oxides such as silicon dioxide, silicon oxide, and silicon oxynitride; nitrides such as silicon nitride and titanium nitride; and polymers such as poly(dimethylsiloxane) (PDMS), polyimide, parylene, and elastomers such as silicone and rubber.

The cantilever shank 22 has a developed length L measured from the base 23 to the tip 24 and a width W₃ measured from one side to a second side of the cantilever shank 22, as illustrated in FIGS. 1 and 2. Preferably, the width W₃ of the cantilever shank 22 ranges from 3 nanometers to 1000 microns, more preferably from 5 nanometers to 100 microns, and most preferably from 20 nanometers to 10 microns. Preferably, the length L of the cantilever shank ranges from 10 nanometers to 1000 microns, more preferably from 10 nanometers to 100 microns, and most preferably from 100 nanometers to 100 microns. The cantilever shank 22 also has a thickness T measured from a top surface 48 of the cantilever shank 22 to a bottom surface 50 of the cantilever shank, as illustrated in FIG. 2. Preferably, the thickness T of the cantilever shank 22 ranges from 3 nanometers to 100 microns, more preferably from 5 nanometers to 100 microns, and most preferably from 20 nanometers to 10 microns. The cantilever shank 22 forms a capillary channel 28 between the base 23 and the tip 24, preferably, in a direction from the base 23 to the tip 24 of the cantilever shank 22, as illustrated in FIG. 1. The capillary channel 28 supplies ink to the tip 24, eliminating the need to re-ink the tip 24 by dipping the tip 24 in a well. Ink is able to travel down the capillary channel 28 in a direction from the base 23 to the tip 24 using surface tension forces. Preferably, the ink can travel down the capillary channel 28 by favorable surface tension forces formed at a fluid front. The capillary channel 28 lies in between two opposing walls 44 and 46 formed in the cantilever shank 22, as illustrated in FIG. 2. The walls 44 and 46 extend from the top surface 48 into the cantilever shank 22 in a direction from the top surface 48 to the bottom surface 50. Preferably the walls 44 and 46 are coated with or comprise a hydrophobic material, such as an organic molecule with at least one hydrophylic end and materials such as silicon nitride and silicon oxide, so that ink can be pulled along the capillary channel 28 in a direction from the base 23 to the tip 24. Forming the walls 44 and 46 out of or coating the walls 44 and 46 with a hydrophobic material would help create a favorable capillary pumping force for moving the ink along the capillary channel 28 in a direction from the base 23 to the tip 24.

The capillary channel 28 has a width WI measured from one wall 44 to the other wall 46. Preferably, the width WI of the capillary channel 28 ranges from 1 nanometer to 10 microns, more preferably from 1 nanometer to 50 nanometers, and most preferably from 10 nanometers to 30 nanometers. Preferably, the capillary channel 28 is formed integrally with the cantilever shank 22 of the SPM probe 20. The capillary channel 28 may be used to deliver ink to the tip 24 of the cantilever shank 22. The ink may comprise any material which may be dispersed or dissolved in a solvent, such as, nucleic acids, proteins, and peptides.

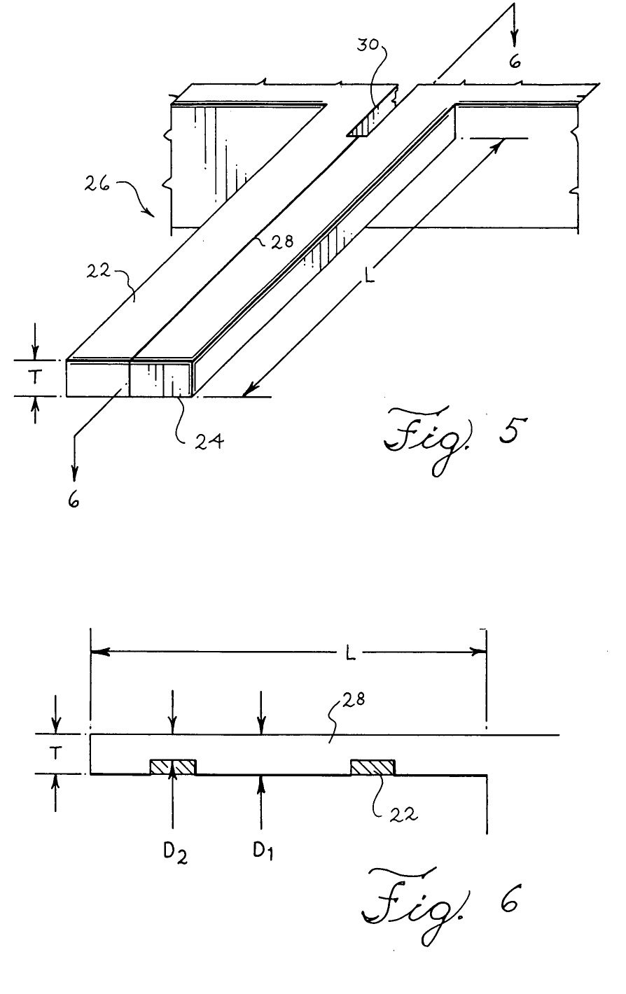

The capillary channel 28 can be formed in the cantilever shank 22 using a number of methods, such as, photolithographic patterning; direct, maskless focused ion-beam etching; and laser machining. Preferably, the capillary channel 28 has a depth D that extends from the top surface 48 into the cantilever shank 22 in a direction from the top surface 48 to the bottom surface 50, as shown in FIG. 2. In one embodiment, at least at one point along the length of the capillary channel 28, a depth D₁ of the capillary channel 28 is equal to the thickness T of the cantilever shank 22, as illustrated in FIG. 6. In another embodiment, at least at one point along the length of the capillary channel 28, a depth D₂ of the capillary channel 28 is less than the thickness T of the cantilever shank 22, as illustrated in FIG. 6.

In one embodiment, the handle 26 forms a reservoir 34 for storing ink, as illustrated in FIG. 1. The reservoir 34 is in fluid communication with the capillary channel 28 which allows for ink stored in the reservoir 34 to flow through the capillary channel 28 and to the tip 24. The reservoir 34 may be formed by, for example, using photolithography or any other method. Preferably a plug 38 is formed and then is provided to seal an opening of the reservoir 34 to prevent ink stored in the reservoir 34 from leaking out of or evaporating from the reservoir 34, as illustrated in FIG. 4. The plug 38 may be formed one of many types of materials such as polymers such as poly(dimethylsiloxane) (PDMS), polyimide, parylene, and elastomers such as silicone and rubber.

In one embodiment, the SPM probe 20 forms a nozzle 30 which is in fluid communication with the capillary channel 28 and the reservoir 34, as illustrated in FIGS. 1 and 2. Preferably, the nozzle 30 has a width W₂ that extends in a similar direction as the width W₁ of the capillary channel 28 and is greater than the width W₁ of the capillary channel 28, as illustrated in FIG. 2. The nozzle 30 is provided to allow fluid communication between the reservoir 34 formed in the handle 26 and the capillary channel 28. Preferably the size of the nozzle 30 should be determined such that fluid in the reservoir 34 will not be lost through the nozzle 30 in an uncontrollable manner. At one end, the nozzle 30 comprises a nozzle opening 32 which is adjacent to and in fluid communication with the reservoir 34, and at an opposing end, the nozzle 30 is connected with and in fluid communication with the capillary channel 28.

In one embodiment, a retaining cap 36 is provided to cover at least a portion of the nozzle 30, as illustrated in FIG. 4. Preferably, the retaining cap 36 covers the entire nozzle 30, including the nozzle opening 32. The retaining cap 36 is provided to prevent ink or fluid from leaking out of or evaporating from the nozzle 30. In one embodiment, the retaining cap 36 covers at least a portion of the capillary channel 28.

It should be noted that there are several advantages to forming a capillary channel 28 in the cantilever shank 22 of the probe 20 instead of building an enclosed micro-fluid channel or tunnel for the delivery of ink from the base 23 to the tip 24 of the cantilever shank 22. First, the fabrication process of the capillary channel 28 requires less steps than other methods which may require sacrificial layer etching of long channels. Second, since the ink flows down the capillary channel 28 open aired, it does not need additional covers on the top surface 48 and the bottom surface 50 of the cantilever shank 22, which increase the stiffness of the cantilever shank 22. Third, since the capillary channel 28 is exposed, the capillary channel 28 can be easily cleaned if necessary.

In one embodiment, the capillary channel 28 reaches the end of the cantilever shank 22 nearest the tip 24 to allow fluid dispensing via the tip 24, as illustrated in FIG. 5. In this embodiment, it is preferable that the cantilever shank 22 is not separated mechanically. One way of achieving this is not to form the capillary channel 28 having a depth D equal to the thickness T of the cantilever shank 22 at every point along the length of the capillary channel 28. In one embodiment, at least at one point along the length of the capillary channel 28 the depth D₁ is equal to the thickness T. In one embodiment, at least at one point along the length of the capillary channel 28 the depth D₂ is less than the thickness T, forming a segments 42, as illustrated in FIG. 6. Thus, the capillary channel 28 still is able to supply the tip 24 with ink while retaining desirable mechanical characteristics.

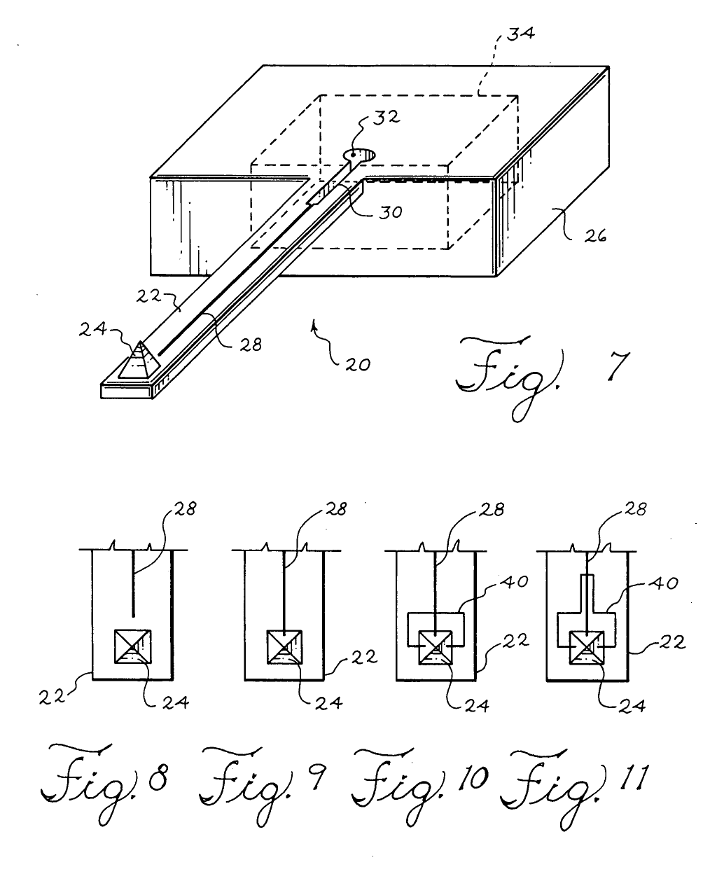

In one embodiment, the capillary channel 28 reaches near the base of the tip 24 such that ink coming out of the capillary channel 28 may diffuse onto the surface of the tip 24, as illustrated in FIG. 8. In one embodiment, the capillary channel 28 comes into contact with the base of the tip 24 such that ink coming out of the capillary channel 28 touches the surface of the tip 24, as illustrated in FIG. 9. In one embodiment, a channel 40 is formed near or around the tip, as illustrated in FIGS. 10 and 11. The channel 40 is in fluid communication with the capillary channel 28 and therefore, allows ink to flow from the capillary channel 28 to the channel 40 and then to the tip 24.

In one embodiment, a fluid valve or pump (not shown) may be integrated into the nozzle 30 for regulating the ink. In one embodiment, an actuator (not shown), such as an actuator based on thermal actuation, electrostatic actuation, magnetostatic actuation, electromagnetic actuation, and piezoelectric actuation, may be integrated with the cantilever shank 22 so that each tip 24 may be individually addressed.

Upon forming the probe 20, the probe 20 may be mounted onto a scanning probe microscope. Upon filling the reservoir 34 with ink, the ink then flows through the nozzle 30 and down the capillary channel 28 to the tip 24. The probe 20 is then positioned and placed near or brought into contact with a substrate, whereupon the ink is transferred from the probe 20 to the substrate in a process referred to herein as printing and/or lithography. The substrate may be any type of material, such as silicon, gold, silver, aluminum, and paper. The tip 24 is positioned using the scanning probe microscope. Preferably, the tip 24 is placed near or brought into contact with the substrate by moving the tip 24 towards the substrate in a first direction. Once the tip 24 is placed near or brought into contact with the substrate, ink is transferred from the tip 24 to the substrate. Upon transferring ink from the tip 24 to the substrate, the tip can either be dragged along the substrate or moved away from the substrate. The probe 20 is compatible with commercial scanning probe machines. The above-described scanning probe printing method combines the chemical versatility and performance advantages of printing with the production flexibility and accuracy of scanning probe microscopes.

Although the invention has been described and illustrated with reference to specific illustrative embodiments thereof, it is not intended that the invention be limited to those illustrative embodiments. Those skilled in the art will recognize that variations and modifications can be made without departing from the spirit of the invention.

1. A method for fabricating a scanning probe microscope probe having a handle and a cantilever shank, the cantilever shank having at one end a base connected with the handle and at and opposing end a tip, the method comprising:
forming a capillary channel between the base to the tip of the cantilever shank.

2. The method of claim 1, wherein the width WI of the capillary channel ranges from 1 nanometers to 50 nanometers.

3. The method of claim 1, wherein the width W₁ of the capillary channel ranges from 10 nanometers to 30 nanometers.

4. The method of claim 1, wherein the forming of the capillary channel comprises using photolithography.

5. The method of claim 1, wherein the forming of the capillary channel comprises using laser machining.

6. The method of claim 1, wherein the forming of the capillary channel comprises using focused ion beam etching.

7. The method of claim 1, wherein the cantilever shank has a thickness T and the capillary channel has a depth D, and wherein at least at one point along the length of the capillary channel the depth D is equal to the thickness T.

8. The method of claim 1, wherein the cantilever shank has a thickness T and the capillary channel has a depth D, and wherein at least at one point along the length of the capillary channel the depth D is less than the thickness T.

9. The method of claim 1, wherein the capillary channel has walls comprising a hydrophobic material.

10. The method of claim 1 further comprising coating walls of the capillary channel with a hydrophobic material.

11. The method of claim 1 further comprising forming a nozzle on the handle, wherein the nozzle is in fluid communication with the capillary channel.

12. The method of claim 1 1, further comprising forming a reservoir in the handle, wherein the reservoir is in fluid communication with the nozzle.

13. The method of claim 12, wherein the nozzle forms an opening that is in fluid communication with the reservoir.

14. The method of claim 12, further comprising sealing the reservoir with a plug.

15. The method of claim 14, wherein the plug comprises an elastomer.

16. The method of claim 13, further comprising covering the nozzle and the nozzle opening with a cap.

17. The method of claim 1, further comprising covering at least a portion of the capillary channel with a cap.

18. The method of claim 11, wherein the capillary channel extends from the nozzle to the end of the cantilever shank.

19. The method of claim 11, wherein the capillary channel extends from the nozzle to the tip.

20. The method of claim 1, further comprising forming an additional channel surrounding the tip and in fluid communication with the capillary channel.

21. A scanning probe microscope probe comprising:
a handle; and
a cantilever shank connected with the handle, the cantilever shank having at one end a base connected with the handle and at an opposing end a tip, wherein the cantilever shank forms a capillary channel between the base to the tip of the cantilever shank.

22. The scanning probe microscope probe of claim 21, wherein the width W₁ of the capillary channel ranges from 1 nanometers to 50 nanometers.

23. The scanning probe microscope probe of claim 21, wherein the width W₁ of the capillary channel ranges from 10 nanometers to 30 nanometers.

24. The scanning probe microscope probe of claim 21, wherein the capillary channel is formed using focused ion beam etching.

25. The scanning probe microscope probe of claim 21, wherein the cantilever shank has a thickness T and the capillary channel has a depth D, and wherein at least at one point along the length of the capillary channel the depth D is equal to the thickness T.

26. The scanning probe microscope probe of claim 21, wherein the capillary channel has walls comprising a hydrophobic material.

27. The scanning probe microscope probe of claim 21, wherein the handle forms a nozzle in fluid communication with the capillary channel.

28. The scanning probe microscope probe of claim 27, wherein the handle forms a reservoir in fluid communication with the nozzle.

29. The scanning probe microscope probe of claim 27, wherein the nozzle forms an opening that is in fluid communication with the reservoir.

30. The scanning probe microscope probe of claim 28 further comprising a plug sealing an opening of the reservoir.

31. The scanning probe microscope probe of claim 28 further comprising a cap on the nozzle and the nozzle opening.

32. A method for printing comprising positioning the scanning probe microscope probe of claim 21 near a substrate, wherein ink is transferred from the capillary channel to the substrate.
